(19) United States
(12) Patent Application Publication
(10) Pub. No.: US 2013/0077461 A1
(43) Pub. Date: Mar. 28, 2013

(54) STORAGE DEVICE

(71) Applicants: Akihiro Koga, Tokyo (JP); Yasushi Tomizawa, Tokyo (JP); Hideo Shinomiya, Kanagawa-ken (JP); Moto Yabuki, Tokyo (JP); Jun Hirota, Kanagawa-ken (JP); Yoshihisa Iwata, Kanagawa-ken (JP); Masayuki Ichige, Kanagawa-ken (JP); Kikuko Sugimae, Kanagawa-ken (JP); Junya Matsunami, Kanagawa-ken (JP)

(72) Inventors: Akihiro Koga, Tokyo (JP); Yasushi Tomizawa, Tokyo (JP); Hideo Shinomiya, Kanagawa-ken (JP); Moto Yabuki, Tokyo (JP); Jun Hirota, Kanagawa-ken (JP); Yoshihisa Iwata, Kanagawa-ken (JP); Masayuki Ichige, Kanagawa-ken (JP); Kikuko Sugimae, Kanagawa-ken (JP); Junya Matsunami, Kanagawa-ken (JP)

(21) Appl. No.: 13/423,755

(22) Filed: Mar. 19, 2012

(30) Foreign Application Priority Data
Sep. 27, 2011 (JP) P2011-211654

(51) Int. Cl. G11B 9/00

(52) U.S. Cl. 369/126; G9B/9

(57) ABSTRACT

A storage device includes a recording medium, a probe, a substrate, and a processing unit. The recording medium stores a signal. The probe reads or writes the signal to/from the recording medium. The substrate is provided with the probe via a conductive anchor interposed therebetween and a first connection terminal connected to the probe. The processing unit is provided on the substrate and has a second connection terminal. The second connection terminal is connected to the first connection terminal.

### CROSS REFERENCE TO RELATED APPLICATION

This application is based upon and claims the benefit of priority from the prior Japanese Patent Application No. 2011-211645, filed on Sep. 27, 2011, the entire contents of which are incorporated herein by reference.

### FIELD

Embodiments relate basically to a storage device.

### BACKGROUND

In a storage device which records and reproduces using probes, a probe unit provided with the probes and a controller for signal processing provided on a substrate are electrically connected to each other via a wire by wire bonding.

However, when signals are transmitted between the probes and the controller via the wire, there is a problem that noise may be induced into the signals due to an electric resistance and the like of the wire.

### BRIEF DESCRIPTION OF THE DRAWINGS

Aspects of this disclosure will become apparent upon reading the following detailed description and upon reference to the accompanying drawings.

FIGS. 1A and 1B are schematic views showing a storage device according to an embodiment.

FIG. 2 is a configuration diagram showing an actuator used in the storage device according to the embodiment.

FIG. 3 is a view showing a cross-sectional structure of the storage device according to the embodiment (cross section taken along A-A of FIG. 2).

FIGS. 4A and 4B are views showing connection of a processing unit and a probe unit used in the storage device according to the embodiment.

FIG. 5 is a configuration diagram showing a probe unit used in the storage device according to the embodiment.

FIGS. 6A and 6B are views showing operation of a control unit used in the storage device according to the embodiment.

### DESCRIPTION

As will be described below, according to an embodiment, a storage device includes a recording medium, a probe, a substrate, and a processing unit. The recording medium stores a signal. The probe reads or writes the signal to/from the recording medium. The substrate is provided with the probe via a conductive anchor interposed therebetween and a first connection terminal connected to the probe. The processing unit is provided on the substrate and has a second connection terminal. The second connection terminal is connected to the first connection terminal.

An embodiment will be described below.

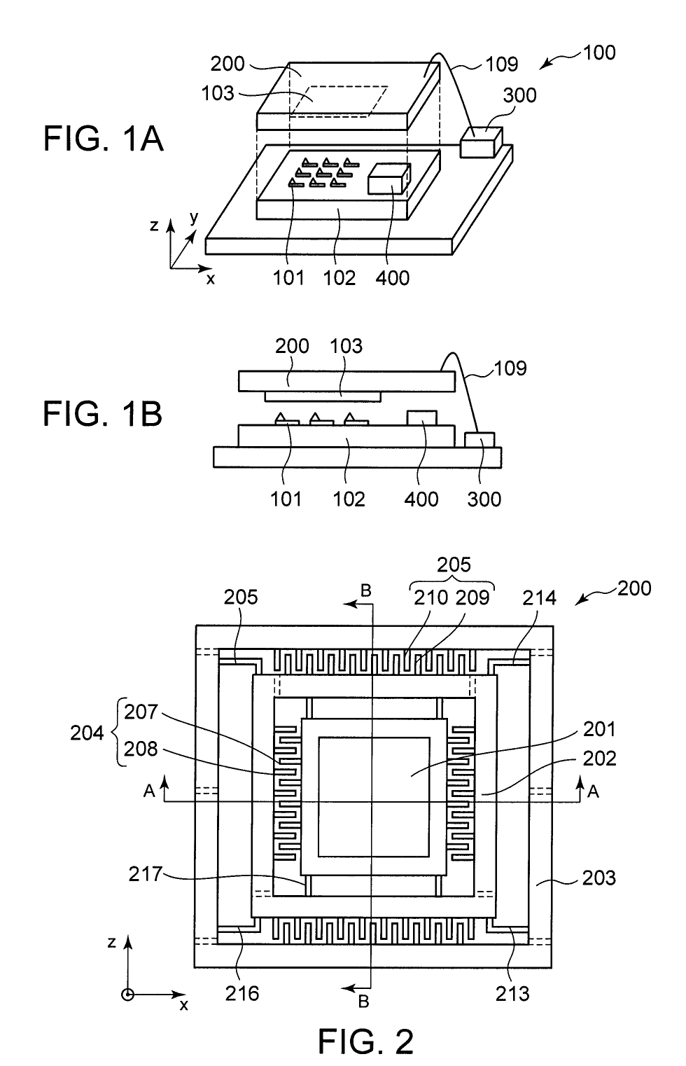

A configuration of a storage device 100 in accordance with the present embodiment will be described in detail with reference to FIGS. 1 to 3.

FIGS. 1A and 1B are schematic views showing the storage device 100 in accordance with the embodiment. FIG. 1A is a perspective view showing the storage device 100. FIG. 1B is a side view showing the storage device 100 in FIG. 1A.

As shown in FIGS. 1A and 1B, the storage device 100 includes a storage medium 103 capable of holding data, a probe unit 102 to which two or more probes 101 are arranged to write/read data to/from the storage medium 103 (hereinafter referred to as (recording/reproduction), an actuator 200 to relatively move the storage medium 103 with respect to the probes 101, a control unit 300 to control driving of the actuator 200, and a processing unit 400 to process signals (data signals) showing data.

The probes 101 of the probe unit 102 are arranged to face the storage medium 103 with a first clearance interposed therebetween. During pause of recording/reproduction in which no recording/reproduction is performed, the probes 101 and the storage medium 103 are separated from each other. During recording/reproduction, the actuator 200 moves the storage medium 103 so that the probes 101 are in contact with the storage medium 103.

In the contact mode, for example, a predetermined voltage is applied to electrodes of the probes 101, so that data are recorded and reproduced between the probes 101 and the storage medium 103. [0014] embodiment will be described with reference to an example where the probe unit 102 includes totally nine probes 101 arranged in a 3×3 matrix.

The storage medium 103 is a thin film capable of holding a change in an electric state as data, for example. In the embodiment, the storage medium 103 includes a thin film of a ferroelectric material.

In the embodiment, an electrostatic actuator capable of driving in triaxial directions (x, y, z axes) is used as the actuator 200.

The actuator 200 shown in FIG. 2 includes a rectangular flat stage (movable-portion) 201, a movable frame 202, and a fixed frame 203. The rectangular flat stage (movable-portion) 201 places the storage medium 103 thereon. The movable frame 202 is around the stage 201 with a second clearance interposed therebetween. The fixed frame 203 is around the movable frame 202 with a third clearance interposed therebetween.

The fixed frame 203 supports the movable frame 202 with conductive support members 213, 214, 215, and 216. In addition, the movable frame 202 supports the stage 201 with a conductive support member 217.

If the plane of the stage 201 is arranged along an xy-plane as shown in FIG. 2, a first drive unit 204 is provided in the second clearance and the first drive unit 204 moves the stage 201 in the x-axis direction of FIG. 2. In the third clearance, a second drive unit 205 is provided to move the stage 201 together with the movable frame 202 as a unit in the y-axis direction. In the first clearance, a third drive unit 206 is also provided and the third drive unit 206 moves the stage 201 in the z-axis direction.

The first drive unit 204 includes two or more first movable-portion electrodes 207 and two or more first fixed-portion electrodes 208 both having the same rectangular shapes and being arranged at regular intervals in one row (y-axis direction). The first movable-portion electrodes 207 on a side surface of the stage 201 and the first fixed-portion electrodes 208 on a side surface of the movable frame 202 respectively protrude in the x-axis direction within the second clearance. In this case, the first movable-portion electrodes 207 and the first fixed-portion electrodes 208 are preferably displaced in the y-axis direction by one-half interval of the same two adjacent electrodes so that both the electrodes 207 and 208 mesh with each other.

This first drive unit 204 moves the stage 201 in the x-axis direction using electrostatic force in the x-axis direction. The electrostatic force acts between a first movable-portion electrode 207 and a first fixed-portion electrode 208 adjacent to each other.

The second drive unit 205 includes two or more second movable-portion electrodes 209 and two or more second fixed-portion electrodes 210 both having the same rectangular shapes and being arranged with a regular interval in one row (x-axis direction). The second movable-portion electrodes 209 arranged on a side surface of the movable frame 202 and the second fixed-portion electrodes 210 arranged on a side surface of the fixed frame 203 protrude in the y-axis direction within the third clearance. In this case, the second movable-portion electrodes 209 and the second fixed-portion electrodes 210 are preferably displaced to mesh with each other by one-half interval of the electrodes in the x-axis direction. In this case, the first movable-portion electrodes 209 and the first fixed-portion electrodes 210 are preferably displaced in the x-axis direction by one-half interval of the same two adjacent electrodes so that both the electrodes 209 and 210 mesh with each other.

The second drive unit 205 moves the stage 201 and the movable frame 202 in the y-axis direction together as a unit using electrostatic force in the y-axis direction. The electrostatic force acts between a second movable-portion electrode 209 and a second fixed-portion electrode 210 adjacent to each other.

More specifically, in the present embodiment, the stage 201, the movable frame 202, and the fixed frame 203 are configured such that the first movable-portion electrodes 207 and the first fixed-portion electrodes 208 are electrically insulated from each other, and the second movable-portion electrode 209 and the second fixed-portion electrode 210 are also electrically insulated from each other.

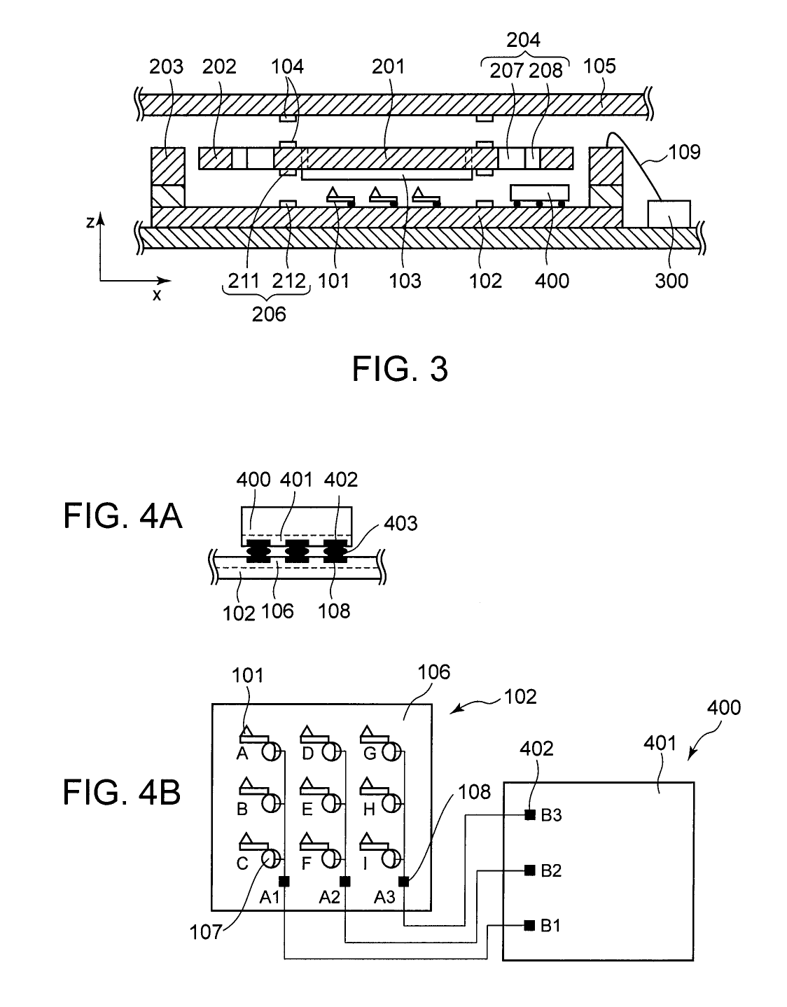

The third drive unit 206 includes a first flat-plate electrode 211 and a second flat-plate electrode 212 both facing each other with sharing a central axis thereof FIG. 3). The first flat-plate electrode 211 is arranged in a peripheral area on the stage 201. The second flat-plate electrode 212 is arranged on the probe unit 102 facing the stage 201 via the first clearance interposed therebetween.

The third drive unit 206 moves the stage 201 in the z-axis direction using electrostatic force in the z-axis direction. The electrostatic force acts between the first flat-plate electrode 211 and the second flat-plate electrode 212. As a result, the probe 101 and the storage medium 103 are in contact with each other.

A cap 105 is a member to package the probe unit 102 and the storage medium 103. Alternatively, the cap 105 may package the control unit 400.

Flat-plate electrodes are arranged at four corners on a surface “A” opposite to the side of the stage 201 holding the storage medium 103 and on a surface “B” of the cap 105. The surface “A” and the surface “B” are arranged to face each other so that the flat-plate electrodes on the surface “A” and the surface “B” also face each other. As a result, such “parallel plate type” electrodes facing each other serve as position sensors. The facing area or distance between the “parallel plate type” electrodes changes to provide changes in electrostatic capacity therebetween. The changes enable it to measure displacements of the stage 201 in the x, y, and z-axes directions. As a result, the flat-plate electrodes configure a position sensor.

As described above, the control unit 300 is a controller to control driving of the first drive unit 204, the second drive unit 205, and the third drive unit 206 of the actuator 200. More specifically, the control unit 300 receives the displacement of the stage 201 measured by the position sensors 104 to calculate the driving voltage of the actuator 200 so that the difference between the actual displacement and a targeted value of the displacement converges to zero. This driving voltage is applied to the actuator 200.

For example, the control unit 300 is implemented by an arithmetic processing unit such as an MPU, and a control circuit 301 (not shown) is provided on the surface of the control unit 300. A connection terminal (not shown) and each drive unit of the actuator 200 are electrically connected via the wire 109. The connection terminal is formed on the control circuit 301.

The processing unit 400 is a controller to process data signals recorded and reproduced by the probe 101. Specifically, the processing determines a recorded state (0) and a non-recorded state (1) of data, and amplifies data signals when the probe 101 reproduces data from the storage medium 103.

The processing unit 400 is implemented by an arithmetic processing unit such as an MPU, and a processing circuit 401 is formed on the surface of the processing unit 400 in the same way as in the above control unit 300.

It should be noted that the first drive unit 204, the second drive unit 205, and the third drive unit 206 are not limited to the electrostatic actuator. Alternatively, a magnetic actuator and a piezoelectric actuator may also be used.

Instead of using the third drive unit 206 to move the stage 201 in the z-axis direction, one probe 101 can be moved or two or more probes 101 can be simultaneously moved in the z-axis direction so that the probe(s) 101 and the storage medium 103 are in contact with or not in contact with each other.

### (Configuration of Processing Unit)

A CMOS process is used to manufacture the control unit 300 and the processing unit 400 with higher accuracy than a MEMS process. The MEMS process is used to manufacture the probe unit 102 and the actuator 200. Hereinafter, the control unit 300 and the processing unit 400 will be referred to as controllers. The probe unit 102 and the actuator 200 will be also referred to as basic units. Accordingly, the processing accuracy of an exposure apparatus, a deposition apparatus, and an etching apparatus (hereinafter referred to as manufacturing apparatuses) used to manufacture the controllers is greatly different from the processing accuracy of manufacturing apparatuses used to manufacture the basic units. Therefore, it is extremely difficult to manufacture the basic units and the controllers within the same wafer because the manufacturing apparatuses are quite different as mentioned above.

There is a method for manufacturing the basic units and the controllers on separate wafers followed by bonding the wafers to each other. However, bonding the wafers to each other requires both the wafers to have the same size. Therefore, there occurs a size discrepancy between the controllers and the basic units. The controllers are preferably miniaturized in order to reduce costs. The basic units preferably increase its area in order to increase its storage capacity.

Accordingly, the following method is used. The basic units and the controllers are manufactured within separate wafers. Chips of the controllers are cut out so that the controllers are provided on a substrate. The chips are electrically connected to the probe unit 102 in the basic units using wire bonding and the like. However, when data signals are transmitted via the wire 109 in this manner, noise is induced by electric resistance of the wire and the like.

In this case, the signal of the driving voltage for the actuator 200 controlled by the control unit 300 has a relatively wide range and is less vulnerable to the noise.

On the other hand, the data signal handled by the processing unit 400 has a narrow range than the signal of the driving voltage handled by the above control unit 300 and is, therefore, more vulnerable to the noise. As described above, it is necessary to amplify the data signals. However, amplifying the data signals amplifies the noise, too. Therefore, when the data signals are transmitted via the wire 109 as described above and the noise is induced, the data signals handled by the processing unit 400 are degraded, thereby making it impossible for the storage device 100 to perform normal recording/reproduction of data.

Accordingly, in the storage device 100 of the present embodiment, a processing circuit 401 of the processing unit 400 handling the data signals that are likely to be vulnerable to the noise is directly provided on the probe unit 102 to face the probe unit 102. Such a configuration can reduce the vulnerability to the noise more than when the processing circuit 401 is provided on the substrate and connected electrically to the probe unit 102 via bonding wire.

Hereinafter, the configuration of the processing unit 400 will be described in detail with reference to FIGS. 4A and 4B. FIG. 4A is an enlarged view showing a contact portion between the probe unit 102 and the processing unit 400 in FIG. 3. FIG. 4B is a diagram showing a connection relationship between the probe unit 102 and the processing unit 400.

In the contact portion between the probe unit 102 and the processing unit 400, a first connection terminal 108 of a unit circuit 106 on the surface of the probe unit 102 and a second connection terminal 402 of the processing circuit 401 of the processing unit 400 are electrically connected via a medium (bump) 403 by flip-chip bonding.

More specifically, as shown in FIG. 4B, the unit circuit 106 of the probe unit 102 is provided with connection terminals A1, A2, A3 as the first connection terminal 108. A probe A, a probe B, and a probe C are connected to a connection terminal A1 via transistors 107, a probe D, a probe E, and a probe F are connected to a connection terminal A2 via transistors 107. A probe G, a probe H, and a probe I are connected to a connection terminal A3 via transistors 107.

The processing circuit 401 of the processing unit 400 is provided with connection terminals B1, B2, B3 as the second connection terminal 402. The connection terminals A1 and B1, the connection terminals A2 and B2, and the connection terminals A3 and B3 are respectively connected to each other.

At this occasion, an anchor 110 is used to fix the probe 101 to the probe unit 102 as the bump 403 for the flip-chip bonding of the above respective two terminals.

For example, the anchor 110 preferably includes a conductive material such as tungsten nitride.

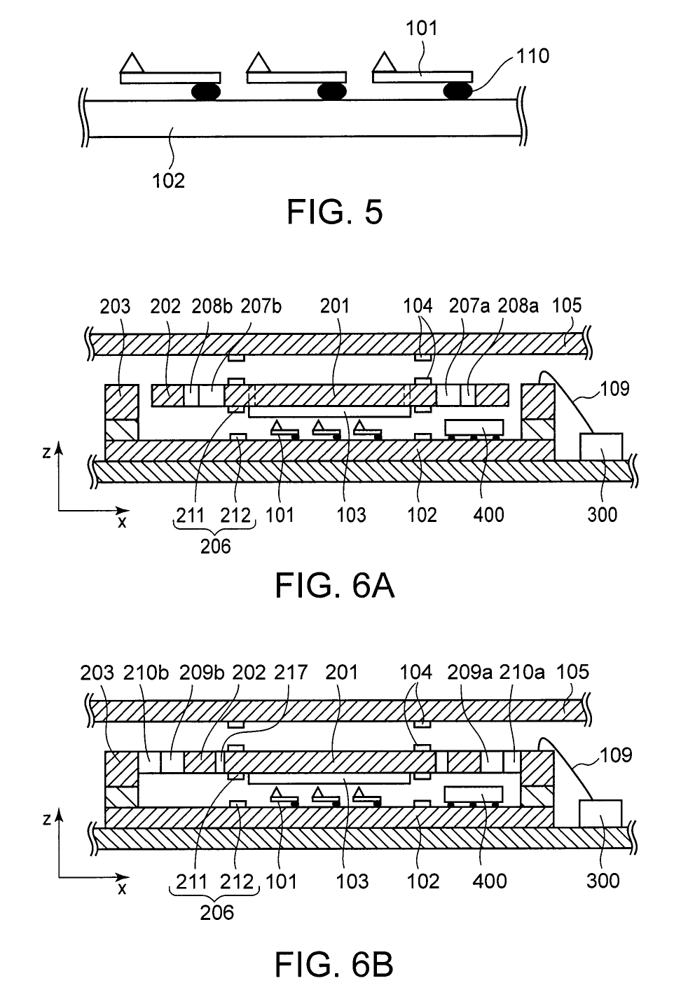

As shown in FIG. 5, the probe 101 is a cantilever beam, wherein one end of the beam of the probe 101 is fixed to the probe unit 102 via the anchor 110. As described above, using the anchor 110 as the bump 403 for connection between both the two terminals enables it to standardize the manufacturing process of the anchor 110 for fixing the probe 101 and the manufacturing process of the bump 403 for the flip-chip bonding and to shorten the manufacturing process of the storage device 100.

In addition, the wiring length between the probe unit 102 and the processing unit 400 can be reduced more than when the processing unit 400 is provided on the substrate and connected by the wire bonding, thereby enabling it to reduce a noise involved in the transmission of data signals. As a result, the storage device 100 can perform normal recording/reproduction of data.

In addition, the probe unit 101 and the processing unit 400 are placed to face each other for flip-chip bonding in order to connect both the first and second connection terminals 108, 402 most shortly. At that time, a distance between the first and second connection terminals 108, 402, the areas thereof, and the shapes thereof are preferably formed so that both the first and second connection terminals 108, 402 can face each other in the same way as the probe unit 101 and the processing unit 400.

Accordingly, in the present embodiment, the distance between the connection terminals A1 and A2 is formed to be equal to the distance between the connection terminals B1 and B2. The distance between the connection terminals A2 and A3 is formed to be equal to the distance between the connection terminals B2 and B3. The areas of the connection terminals A1, A2, A3, B1, B2, and B3 are formed to be the same.

Hereinafter, operation of the control unit 300 will be described with reference to FIGS. 6A and 6B.

### (Drive in Z-Axis Direction)

The control unit 300 applies voltages V1 and V2 to the first flat-plate electrode 211 and the second flat-plate electrode 212, respectively (where, V1≠V2).

At this occasion, electrostatic force (attractive force) is generated by potential difference (V1-V2) between the first flat-plate electrode 211 and the second flat-plate electrode 212. The electrostatic force attracts the first flat-plate electrode 211 to the side of the second flat-plate electrode 212 (positive side in the z-axis direction) so that the stage 201 moves in the z-axis direction.

### (X and Y-Axes Drive)

As described above, the control unit 300 drives the stage 201 in the x- and y-axes directions in addition to the z-axis direction, thereby positioning the probe 101 within the plane of the storage medium 103.

FIG. 6A is a sectional view cut along A-A of FIG. 2.

The control unit 300 applies a voltage V1 to the first movable-portion electrodes 207a and 207b via, e.g., an electrode pad (not shown). At the same time, voltages V2 and V3 are applied to the first fixed-portion electrodes 208a and 208b, respectively (where, V2>V1, V3>V1).

When V2>V3 holds, |V2-V1|>|V3-V1| is satisfied. Accordingly, the electrostatic force in the x-axis direction between the first movable-portion electrode 207a and the first fixed-portion electrode 208a is more than the electrostatic force in the x-axis direction generated between the first movable-portion electrode 207b and the first fixed-portion electrode 208b, thereby allowing the stage 201 to move to the positive side in the x-axis direction.

In the contrary, when V3>V2 holds, |V3-V1|>|V2-V1| is satisfied. Accordingly, the electrostatic force in the x-axis direction between the first movable-portion electrode 207b and the first fixed-portion electrode 208b is more than the electrostatic force in the x-axis direction between the first movable-portion electrodes 207a and the first fixed-portion electrode 208a, thereby allowing the stage 201 to move to the negative side in the x-axis direction.

FIG. 6B is a view showing a section cut along B-B of FIG. 2.

The control unit 300 applies voltages V4 and V5 to the second movable-portion electrodes 209a and 209b, respectively, via, e.g., an electrode pad (not shown). At the same time, voltages V6 and V7 are applied to the second fixed-portion electrode 210a and 210b, respectively (where, V6>V4, V7>V5).

When |V6-V4|>|V7-V5| holds, the electrostatic force between the second movable-portion electrode 209a and second fixed-portion electrode 210a is larger than the electrostatic force between the second movable-portion electrode 209b and the second fixed-portion electrode 210b, thereby allowing the stage 201 to move to the positive side in the y axis direction.

In the contrary, when |V7-V5|>|V6-V4| holds, the electrostatic force between the second movable-portion electrode 209b and the second fixed-portion electrode 210b is more than the electrostatic force between the second movable-portion electrode 209a and the second fixed-portion electrode 210a, thereby allowing the stage 201 to move to the negative side in the y-axis direction.

### (Operation of Processing Unit)

Hereinafter, operation of the processing unit 400 will be described with reference to FIG. 4 again.

### (Recording/Reproduction)

When the probe 101 and the storage medium 103 are in contact with each other, the electrodes of the stage 201 and probe 101 partially form a ferroelectric capacitor with the storage medium 103 including a ferroelectric material interposed therebetween. Then, as described above, the control unit 300 positions the probe 101 relatively with respect to the storage medium 103, and the processing unit 400 records/reproduces data to/from the storage medium 103.

More specifically, during recording, the processing unit 400 applies the voltage to the storage medium 103 via the electrodes of the probe 101, thereby causing charge polarization in the storage medium 103 to record data.

On the other hand, during reproduction, the control unit 300 applies the pulse voltage to the storage medium 103 via the electrodes of the probe 101, thereby detecting a current generated by polarization reversal of charge as a data signal. Then, the data signal detected is amplified. Data are reproduced as follows. For example, when the data signal has a predetermined threshold value or less, a non-recorded state (0) is to be determined. When the data signal has a predetermined threshold value, a recorded state (1) is to be determined.

For example, the probes 101 as shown in FIG. 4 can record/reproduce data in such a manner that one probe 101 in each of rows A, B, and C switches the transistors 107 to apply a voltage to the storage medium 103. In this manner, all the probes 101 (the three probes 101 in FIG. 4) are connected just to the first connection terminal 108, thereby enabling it to reduce the number of connection terminals included in the unit circuit 106 of the probe unit 102 and the processing circuit 401 of the processing unit 400.

Accordingly, the probe unit 102 can increase its area to arrange the probes 101 on the area, i.e., the storage capacity. The processing unit 400 can reduce its chip area.

Alternatively, the storage medium 103 may include an insulating film made of a metallic oxide. In such a case, changes in resistance of the storage medium 103 are caused by a voltage applied from the probe 101. The changes are treated as data to enable recording/reproduction of the data.

The present embodiment has been described as an example. That is, all the (three) probes 101 are connected just to the first connection terminal 108 of the unit circuit 106 of the probe 102 and the respective transistors 107 switch in the connections. Alternatively, the probes 101 and the first connection terminal 108 may be configured for one by one connection.

As a result, it is not necessary to provide the transistors 107. The simultaneous recording/reproduction using the probes 101 enables rapid recording/reproduction.

Hereinafter, a manufacturing process of the storage device 100 in accordance with the present embodiment will be described as an example.

### (Unit Circuit)

The unit circuit 106 including the transistors 107 is formed as follows. A circuit pattern is transferred onto a substrate such as a silicon wafer using a normal photolithography technique.

### (Anchor and Probe)

A thin film of silicon oxide is deposited as a sacrifice layer onto the probe unit 102. Then, an exposure/etching step for opening windows in the thin film is conducted on the regions where the anchors 110 are made (including the first connection terminals 108 of the unit circuit 106). Then, a conductive material of the anchor 110 is deposited by sputtering, CVD, or the like. Then, the surface of the anchor 110 deposited is smoothed by CMP and the like.

Subsequently, the probes 101 are shaped by repeating the deposition, exposure, and etching in the same way. Only the thin film, i.e., the sacrifice layer, is selectively removed by etching. Then, heat is applied finally. As a result, the adhesion between the anchors 110 and the probes 101 is enhanced to bond both the anchors 110 and the probes 101. The anchors 110 and the probes 101 thereon can be formed through the above steps.

In addition, no probe 101 is formed on the anchors 110 on the first connection terminals 108 of the unit circuit 106.

### (Processing Unit)

The processing unit 400 is bonded onto the probe unit 102 as follows. In the manufacturing steps of the above anchor 110, the anchors 110 and the second connection terminals 402 are positioned with each other and mounted in face-down using a flip-chip bonder. The anchors 110 are formed on the first connection terminals 108 of the unit circuit 106. The second connection terminals 402 are of the processing circuit 401 of the processing unit 400.

In accordance with the storage device of the embodiment described above, the noise involved in the signal can be reduced.

While certain embodiments have been described, those embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device, comprising:
a recording medium to store a signal;
a probe to record/reproduce the signal to/from the recording medium;
a substrate, the substrate having the probe via a conductive anchor interposed therebetween and a first connection terminal connected to the probe; and
a processing unit being provided on the substrate and having a second connection terminal, the second connection terminal being connected to the first connection terminal.

2. The storage device according to claim 1, wherein
the first connection terminal and the second connection terminal are bonded via a conductive bump by flip-chip bonding.

3. The storage device according to claim 2, wherein
the anchor is used as the bump.
